(19) United States
(12) Patent Application Publication
(10) Pub. No.: US 2025/0041788 A1
(43) Pub. Date: Feb. 6, 2025

(54) EFFICIENT ADAPTABLE SYSTEM FOR CAPTURING CARBON

(71) Applicant: Harrison Rice, Honolulu, HI (US)

(72) Inventors: Harrison Rice, Honolulu, HI (US); R Barrett Kotnik, Oswego, IL (US)

(21) Appl. No.: 18/922,738

(22) Filed: Oct. 22, 2024

Related U.S. Application Data
(63) Continuation-in-part of application No. 17/958,306, filed on Sep. 30, 2022.
(63) Continuation-in-part of application No. 18/438,397, filed on Feb. 9, 2024.

(30) Foreign Application Priority Data
Sep. 20, 2023 (WO) PCT/US23/74663

(51) Int. Cl. B01D 53/14; B01D 53/18; B01D 53/62; B01D 53/79; B01D 53/96

(52) U.S. Cl. CPC B01D 53/1475; B01D 53/1412; B01D 53/1425; B01D 53/1431; B01D 53/185; B01D 53/62; B01D 53/79; B01D 53/96; B01D 2257/504; B01D 2258/06

(57) ABSTRACT

A carbon capture system using an efficient method of capturing carbon dioxide is disclosed herein. The carbon capture system described is scalable in shape and size and can be adjusted to achieve different volumetric airflow rates. This method is efficient due to the maximum surface area to volume ratio achievable in a carbon capture system with the distribution of equally or randomly spaced spray nozzles configured to distribute carbon capture substance throughout the interior of the system. The substance interacts with air and absorbs carbon dioxide, as a result, large amounts of carbon dioxide are captured within the system. The system gains further efficiency by filtering the carbon capture substance laden with carbon dioxide through one or more coil separating elements, designed to maximize the flow of air through the coil separating element while simultaneously maximizing the ability to separate carbon capture substance from the air before exiting the system. The carbon capture system may or may not reuse carbon capture substance to minimize waste.

### CROSS-REFERENCE TO RELATED APPLICATIONS

This application claims the benefit of U.S. Non-Provisional patent application Ser. No. 17/958,306 filed on Sep. 30, 2022, entitled “SYSTEM AND METHOD FOR CAPTURING CARBON TO REMOVE CARBON DIOXIDE FROM THE ATMOSPHERE”, which is incorporated herein by reference in its entirety. This application also claims the benefit of U.S. Non-Provisional patent application Ser. No. 18/438,397 entitled “EFFICIENT LOW-PRESSURE DROP SYSTEM AND METHOD FOR CAPTURING CARBON”, which are incorporated herein by reference in its entirety.

### BACKGROUND OF THE INVENTION

There is a need in the art for an efficient, fast-operating carbon capture system in which a maximum amount of carbon dioxide is removed from the atmosphere.

### SUMMARY OF THE INVENTION

Disclosed herein is a carbon capture system comprising: a carbon capture system comprising, a) a structure, wherein the structure is hollow, b) a carbon capture substance for distribution within the structure, c) at least one drift control element, wherein the at least one drift control element is attached to the structure, wherein the at least one drift control element prevents outside air from removing the carbon capture substance from the structure, d) at least one distribution element configured to distribute the carbon capture substance into air inside the structure, wherein the air passes through the at least one drift control element, c) at least one wind speed sensor, wherein the at least one wind speed sensor is attached to the structure a), f) at least one diverter element, wherein the at least one diverter element is controlled by the wind speed sensor e), at least one separator inlet, wherein the air and an amount less than or equal to approximately 100% of the carbon capture substance b) from the structure a) enter the separator inlet c), g) at least one coil separator, wherein the at least one coil separator is attached to the separator inlet e) comprising, a) at least one exhaust outlet, wherein the air exits the at least one coil separator g), h) at least one air moving element, wherein the air moving element pulls air through the at least one coil separator g), wherein the at least one air moving element is configured to be diverted, wherein the at least one air moving element is controlled by the wind speed sensor f), and i) at least one primary collection area, wherein the carbon capture substance is captured in the at least one primary collection area.

It should be noted the at least one wind speed sensor e) detects a wind velocity thereafter opening the at least one diverter element f) to direct air away from at least one air moving element h). In addition, the at least one wind speed sensor e) detects a wind velocity thereafter closing the at least one diverter element f) to direct air toward at least one air moving element h). The at least one coil separator g) is configured to change the direction of the air and the carbon capture substance, thereby change in direction results the air and the carbon capture to pick up a radial component of acceleration. It should be noted that the slings the carbon capture substance against a j) surface inside the at least one coil separator g). Additionally, the carbon capture substance is collected after the carbon capture substance contacts the surface j), wherein the air exists the at least one coil separator g) via at least one exhaust outlet a).

Also disclosed in another embodiment disclosed herein is a carbon capture system comprising carbon capture system comprising, a) a structure, wherein the structure is hollow b) a carbon capture substance for distribution within the structure, c) at least one drift control element, wherein the at least one drift control element is attached to the structure, wherein the at least one drift control element prevents outside air from removing the carbon capture substance from the structure a), d) at least one distribution element configured to distribute the carbon capture substance into air inside the structure a), wherein the air passes through the at least one drift control element d), c) at least one separator inlet, wherein the air and an amount less than or equal to approximately 100% of the carbon capture substance from the structure a) enter the separator inlet e), f) at least one coil separator, wherein the at least one coil separator is attached to the separator inlet comprising, a) at least one exhaust outlet, wherein the air exits the at least one coil separator f), g) at least one air moving element, wherein the air moving element pulls air through the at least one coil separator f) and at least one primary collection area, wherein the carbon capture substance is captured in the at least one primary collection area.

It should be noted that at least one air moving element g) pulls the air through the at least one coil separator and out the at least one exhaust. In addition, the at least one coil separator g) is configured to change the direction of the air and the carbon capture substance, thereby the change in direction results the air and the carbon capture substance to pick up a radial component of acceleration. Additionally, the radial component of acceleration slings the carbon capture substance against the surface inside the at least one coil separator g). It should be noted that the carbon capture substance is collected after the carbon capture substance contacts the surface, wherein the air exits the at least one coil separator via at least one exhaust outlet.

### DESCRIPTION OF THE DRAWINGS

FIG. 1 illustrates the components of a system for capturing carbon to remove carbon dioxide from the atmosphere as configured in accordance with one or more embodiments of the invention.

FIG. 2 illustrates a top view of the system of capturing carbon to remove carbon dioxide from the atmosphere as configured in accordance with one or more embodiments of the invention.

FIG. 3 illustrates a spray nozzle configuration within a distribution element utilized within the system in accordance with one or more embodiments of the invention.

FIG. 4 illustrates a charged carbon capture element with a fan or fans as configured in accordance with one or more embodiments of the invention.

FIG. 5 illustrates another embodiment of capturing carbon to remove carbon dioxide from the atmosphere. In this embodiment the charged capture element is not attached to the structure.

FIG. 6 illustrates another embodiment of capturing carbon to remove carbon dioxide from the atmosphere. In this embodiment an inlet particle separator is used to pull in and capture carbon dioxide from the electrically charged carbon capture fluid particulate.

FIG. 7 illustrates a method for capturing carbon to remove carbon dioxide from the atmosphere as configured in accordance with one or more embodiments of the invention.

FIG. 8 illustrates another embodiment of a method for capturing carbon to remove carbon dioxide from the atmosphere.

FIG. 9 illustrates another embodiment of the top view of the carbon capture system implemented with a swirling separator and exhaust pipes used to push clean air out of the structure into the atmosphere.

FIG. 10 illustrates a swirling separator, and exhaust.

FIG. 11a illustrates a carbon capture system with an exhaust particle separator attached to the system.

FIG. 11b illustrates a cross section of the carbon capture system with an efficient swirling separator attached to the system.

FIG. 11c illustrates a carbon capture system with an exhaust particle separator attached to the top of the system.

FIG. 12 illustrates a carbon capture system with an efficient swirling separator attached to the system.

FIG. 13 illustrates an efficient swirling separator and the air moving element cross section.

FIG. 14 illustrates a method of capturing carbon dioxide from the atmosphere.

FIG. 15 illustrates a carbon capture system with efficient coil separators attached to the system. FIG. 16 illustrates an efficient off axis coil separator.

FIG. 17 illustrates an efficient on axis coil separator.

FIG. 18 illustrates an efficient Carbon capture system with coil separators, diverters and wind speed sensors and Diverter cross-section.

### DETAILED DESCRIPTION

A system and method to remove and capture carbon dioxide from the atmosphere will now be described in accordance with one or more embodiments of the invention. In the following exemplary description numerous specific details are set forth to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity, or importance, but rather are used to distinguish one element from another, and the terms “a” and “an” herein do not denote a limitation of quantity, but rather denote the presence of at least one of the referenced items.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

References. The description of the figures provided herein contains references to each depicted component. A list of these components described in the context of each figure is provided below for easy reference.
100 Structure
102 First Intake
104 Electrically insulated Mixer
106 Distribution Element
108 Electrically Charged or Neutral Carbon Capture Fluid
110 Charged Capture Element
112 Air from the Atmosphere
114 Air inside structure (internal air)
116 Electrically Insulated Paddle
118 Carbon Capture Fluid Mixes with Air
120 Resultant Particulate
122 Fans
124 Residuary Air
126 Carbon Capture Fluid reused
200 Grate
300 Spray Nozzles
302 Pipes
400 Holding Reservoir
402 Curved Point of the Fan
404 Outer Housing
406 Inner Housing
600 Exhaust particle separator
700 Intaking Air
702 Charging Carbon Capture Fluid
704 Injecting Carbon Capture Fluid into Structure
706 Capturing Carbon Dioxide from Air
708 Separating Carbon Dioxide from Air
710 Moving Air within the Structure
712 Reusing Carbon Capture Fluid
800 Stirring Air and Carbon Capture Fluid
802 Circulating Carbon Capture Fluid
804 Releasing Carbon Dioxide into the Outer Housing
900 Exhaust
902 Combined Clean Air Exhaust Pipe
1002 Vanes
1004 Apex Turn
1006 Second Fixed Blades
1010 Primary Collection Area
1012 Recirculating Pipe
1014 Electric Motor
1016 Cone
1100 Carbon Capture Substance
1106 Drift Control Element
1108 Air Moving Element
1110 Carbon Capture Substance Collection element
1112 Separator Inlet
1114 Internal exhaust inlet
1200 Swirling Separator
1201 Efficient Swirling Separator
1400 Placing Carbon Capture Substance Inside structure
1402 Mixing Carbon Capture Substance and Air
1404 Pushing Air Outside structure
1406 Extracting Carbon Capture Substance
1408 Separating Carbon Capture Substance from Air
1600 Off-axis Coil Separator
1602 Surface
1604 Separator Outlet
1700 On-axis Coil Separator
1800 Wind speed sensor
1802 Diverter element
1804 Damper

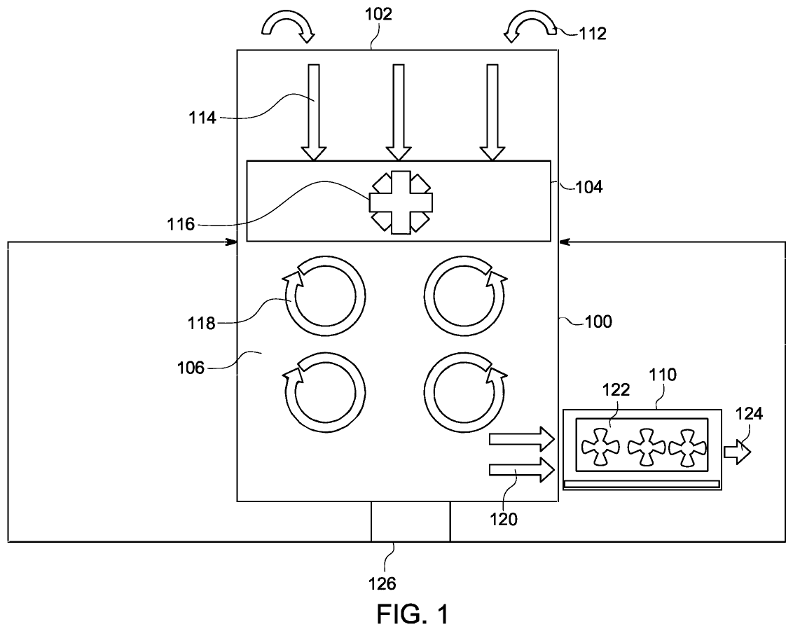

FIG. 1 illustrates the components of a system for capturing carbon to remove carbon dioxide from the atmosphere as configured in accordance with one or more embodiments of the invention. The system is typically contained within a structure (100) of sorts built to house the various system components. Structure (100) here can include but is not limited to a, housing, and system. This structure (100) provides a housing within which other system elements are contained and may take various shapes and sizes dependent upon the volume of air to be processed by the system. In accordance with one or more embodiments of the invention, this structure (100) comprises a first intake (102), an electrically insulated mixer (104) a distribution element (106), carbon capture fluid (108), and a charged capture element (110). The air from the atmosphere (112) enters the structure (100) through the first intake (102). The first intake (102) is not limited to any specific shape or structure so long as the first intake (102) is built in a way that enables airflow while minimizing the ability for debris from outside to enter the structure (100). The electrically insulated mixer (104), which is comprised of an electrically insulated paddle (116), allows the carbon capture fluid to flow into the distribution element (106) via pipes (302). The electrically insulated mixer (104) is not limited to an electrically insulated paddle (116) and can also be implemented with an equivalent mixing mechanism. The electrically insulated mixer (104) can be abutted to a distribution element (106) which is comprised of an array of spray nozzles (300) that spray electrically charged carbon capture fluid (108) throughout the structure (100). The carbon capture fluid (108) is not limited to an electrical charge and can be configured to have a neutral charge.

However, in this embodiment, the carbon capture fluid (108) is configured to be electrically charged. The distribution element (106) is not limited to spray nozzles (300) and can instead be comprised of any apparatus that's able to distribute a liquid or fine particulate within the distribution element (106). The plurality of spray nozzles (300) or equivalent liquid distribution apparatus can be arranged in any manner or pattern. The spray nozzles (300) can be either equidistant or randomly spaced within the distribution element (106). The equidistant property of the spray nozzles (300) allows for the maximum distribution of the electrically charged carbon capture fluid (108).

The carbon capture substance (1100) which can be but is not limited to a carbon capture fluid (108) which can be solvents or sorbents, where the carbon dioxide is absorbed into the substance, can be made with but is not limited to: primary amines such as monoethanolamine (MEA), isobutylamine (IBA), ethylamine, propylamine, secondary amines such as diethanolamine (DEA), piperazine (PZ), diisopropylamine (DIPA), 2-methylaminoethanol (MAE) tertiary amines such as tetraethylenepentamine (TEPA), N-methyldiethanolamine (MDEA), 2-(dimethylamino) ethanol (DMEA), N-diethylethanolamines (DEEA), 2-amino-1-methyl-2-propanol (AMP), aqueous solutions with ionic concentration such as potassium hydroxide (KOH), sodium hydroxide (NaOH) powdered hydroxides and the like. In addition, the combination can also include water.

Before the electrically charged carbon capture fluid (108) is sprayed throughout the structure (100), it is initially injected externally or internally into the structure (100). The electrically charged carbon capture fluid (108) is blocked from leaving the electrically insulated mixer (104) because of the electrically insulated paddle (116). The blocking of the electrically charged carbon capture fluid (108) is not limited to the electrically insulated paddle (116) but can be also achieved by any other blocking mechanism such as a fan or another equivalent structure which stops the electrically charged carbon capture fluid (108) from leaving the electrically insulated mixer (104). The sprayed electrically charged carbon capture fluid (108) that comes out of the array of spray nozzles (300), interacts and mixes with air (118) within the distribution element (106). The mixing or stirring of air inside the structure (118) and the electrically charged capture fluid (108) results in the trapping of carbon dioxide from the air inside the structure (114) within the distribution clement (106). The stirring or mixing of air inside the structure (118) and the electrically charged carbon capture fluid (108) can be achieved with either air or with the electrically insulated paddle (116). The resultant particulate (120) is then captured by a charged capture element (110), which can be placed inside or outside of the structure (100). The charged capture clement (110) is comprised of either a single or a plurality of fans (122). The fan or fans (122) within the charged carbon capture element (110) helps push out residuary air (124) and store captured carbon dioxide. The charged capture element (110) is also configured to have a charge opposite polarity to the charge of the particulate (120) that is distributed throughout the distribution element (106). The charged capture element (110) is not just limited to a fan or fans (122) and the polarity of the charged capture element (110). The charged capture element (110) can be configured to function with only fans (122) or only electrical charge in order to attract the resultant particulate (120). The charged capture element (100) can be any particulate capturing mechanism. The captured carbon dioxide remains within the charged capture element (110) and the residuary air (124) flows out of the charged capture element (110). The residuary air (124) can flow out of the charged capture element (110) with or without the assistance of fans (122) and exhaust (900) which can be either a pipe or a flat structure. The remaining electrically charged carbon capture fluid (108) is collected and reused (126) by the structure (100). The carbon capture system can be configured to not reuse (126) the remaining electrically charged carbon capture fluid (108). Instead, the carbon capture system can dump or store the remaining electrically charged carbon capture fluid (108).

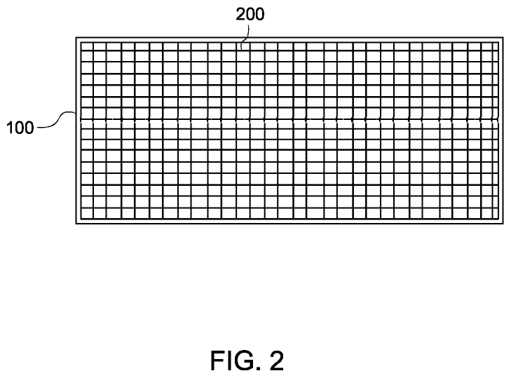

FIG. 2 illustrates the top view of the carbon capture system. The first intake (102) of the structure (100) includes a grate (200) which can be attached to the structure (100). The grate (200) is not limited to a shape or pattern and can be configured to allow air from the atmosphere (112) to enter the structure (100) while not allowing debris to enter the structure (100) or carbon capture substance to exit. In addition, the first intake (102) can be configured without the use of the grate (200). Examples of other types of grates (200) shapes that can be used in the first intake (102) are triangular, rectangular, circular or any other polygon that can be configured to be a grate (200).

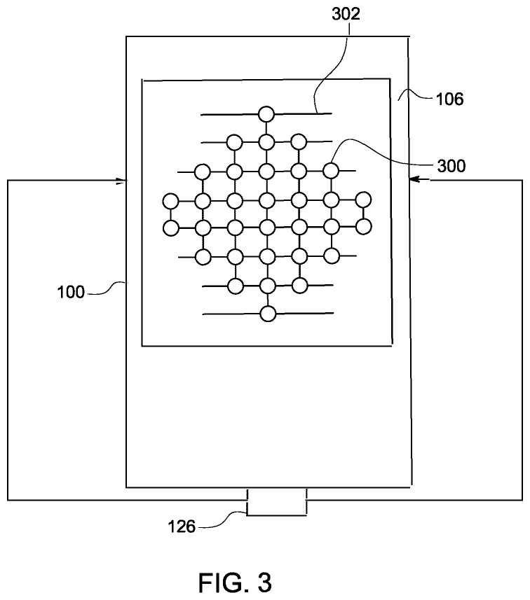

FIG. 3 illustrates the components of the distribution element (106) as configured in accordance with one or more embodiments of the invention. The system is typically contained within a structure (100) of sorts built to house the various system components. The distribution element (106) is comprised of a plurality of pipes (302), and a plurality of spray nozzles (300). The distribution element (106) is not limited to pipes (302) and spray nozzles (300) but can be configured as a liquid or particulate distribution network, which distributes liquid or particulate throughout the system. The spray nozzles (300) can be arranged in any manner or pattern. Adjacent nozzles (300) can be spaced equidistantly or randomly from each other. The equidistant property of the spray nozzles (300) allows for the maximum distribution of the electrically charged carbon capture fluid (108). As electrically charged carbon capture fluid (108) is injected into the structure (100), it enters the pipes (102) or any other kind of entry mechanism in which the electrically charged carbon capture fluid (108) enters the structure (100). The pipes (302) then carry the electrically charged carbon capture fluid (108) to each of the spray nozzles (300) within the distribution element (106). In addition, the pipes (302) are configured to minimize the loss of charge of the electrically charged carbon capture fluid (108). This can be accomplished by making the pipes (302) out of an insulator-based material such that the electrically charged carbon capture fluid (108) does not lose significant amount of charge as it is distributed throughout the distribution element (106). The pipes (302) can also be configured to be made from conductor type materials. The minimization of charge loss will allow the electrically charged carbon capture fluid (108) to capture more carbon dioxide from the air inside the structure (114). The more carbon dioxide is captured from the air inside the structure (114) the more efficient the carbon capture system is. Within the distribution clement (106) the air within the structure (114) and the electrically charged carbon capture fluid (108) interact and mix (118) resulting in a particulate (120). The resultant particulate (120) is a combination of air and electrically charged carbon capture fluid (108). In addition, carbon dioxide is also contained in the particulate (120) because the carbon dioxide was in the air from the atmosphere (112) as it entered the structure (100). The more resultant particulate (120) is produced within the distribution clement (106), the more carbon dioxide can be captured.

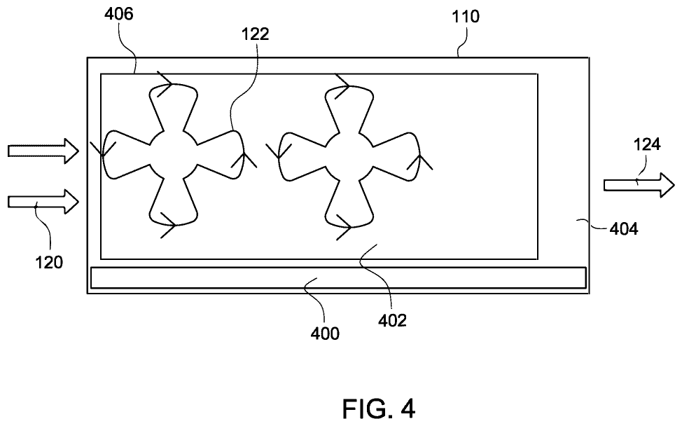

FIG. 4 illustrates a charged capture element (110), which is comprised of but not limited to a fan or a plurality of fans (122), a holding reservoir (400), a curved point of the fan (402), an outer housing (404) and an inner housing (406). The charged capture element (110) can be attached to the structure (100) and is configured to have an opposing electrical charge from the electrically charged carbon capture fluid (108) such that the resultant particulate (120) bonds to the fan or fans (122) when passing through the fan or fans (122). The charged carbon capture element (108) is not limited to the fans (122) and its charge within the structure (100). Instead, it can be configured to function with just the fan or fans (122) or just the electric charge when attracting the resultant particulate (120). As the resultant particulate (120) leaves the distribution element (106), it enters the charged capture clement (110). In one embodiment, the fan or fans (122) pull in the resultant particulate (120) inside the charged capture element (110). The fan or fans (122) inside the charged capture element (110) extend across the inner portion of the housing (406) into the outer portion of the housing (404) within the charged capture element (110). The function of the outer housing (406) of the charged capture clement (110) is to collect the resultant particulate (120), which is made up from electrically charged carbon capture fluid (108) and captured carbon dioxide, from the air inside the structure (114). The fan or fans (122), inside the charged capture element (110) have a curved end point at the fan ends (402). The curved point on the fan (402) is not limited to a distinct shape, but rather the fan (122) is configured such that it captures the maximum amount of resultant particulate (120). The curved point on the fan (402) captures the particulate (120) using centrifugal force. The holding reservoir (400) within the charged capture element (110) collects the remaining particulate (120). The charged capture element (110) is not limited to the holding reservoir (400) and can be instead configured to hold the resulting particulate in any alternate holding or storing mechanism. The resultant particulate (120) inside the holding reservoir (400) can be reused (126) by the structure (100). As stated, the resultant particulate (120) can be reused (126) or stored or discarded. The reuse of the particulate (126) allows the system to use all the left over particulate and not waste or discard any amount. The reuse (126) in turn allows the system to be more efficient.

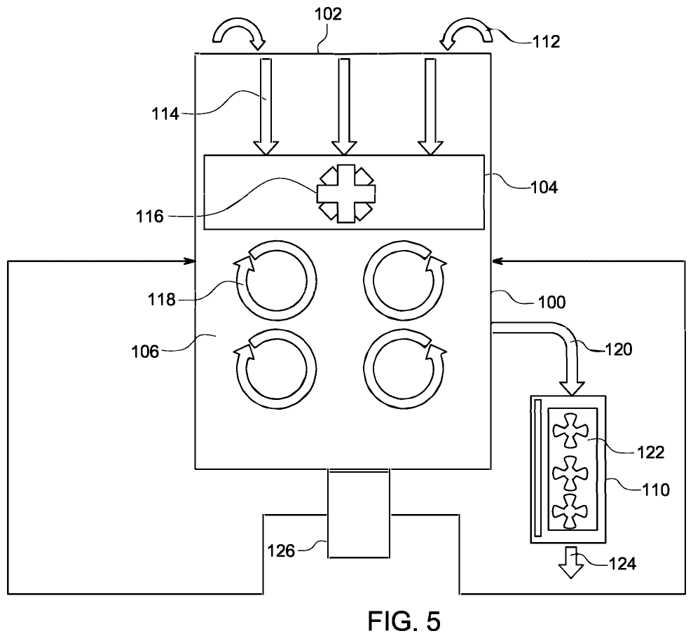

FIG. 5 illustrates another embodiment of the carbon capture system where the components of a system are contained within a structure (100) of sorts built to house the various system components. This structure (100) provides a housing within which other system elements are contained and may take various shapes and sizes dependent upon the volume of air to be processed by the system. The structure (100) comprises of a first intake (102), an electrically insulated mixer (104) a distribution element (106), an electrically charged carbon capture fluid (108), and a charged capture clement (110). In this embodiment, the charged capture element (110) is not abutted to the structure (100) but rather spaced away from the structure (100) in a vertical orientation which allows the resultant particulate (120), that comes out of the distribution clement (106) within the structure (100), to be removed via centrifugal force. The resultant particulate (120) is then collected outside the structure (100) and from that point gravity pulls the particulate (120) downward into the charged capture element (110).

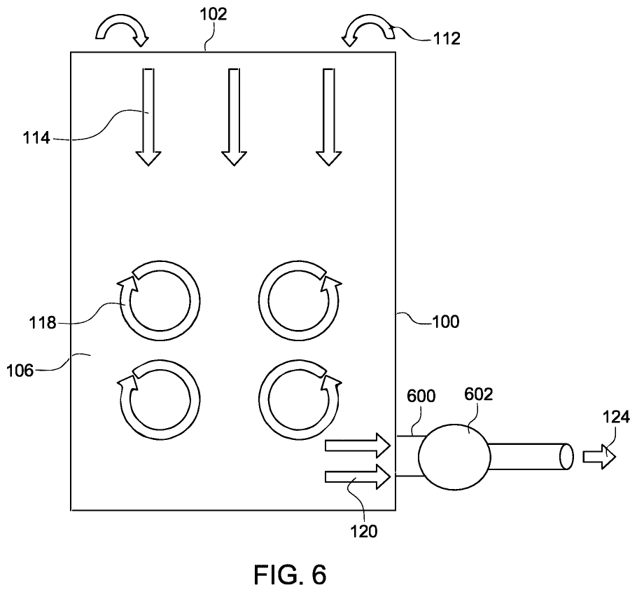

FIG. 6 illustrates an alternate embodiment of the carbon capture system where the components of a system are contained within a structure (100) of sorts built to house the various system components. This structure (100) provides a housing within which other system elements are contained and may take various shapes and sizes dependent upon the volume of air to be processed by the system. The structure (100) comprises of a first intake (102), a distribution element (106), a carbon capture fluid (108), an exhaust particle separator (600) and an air moving element (1108). The exhaust particle separator (600) can be attached to the structure (100) on one side and attached to the (air moving element (1108) on the other side. The exhaust particle separator (600) and the air moving element (1108) both create suction in the structure (100) and remove particulate (120) from the air that is inside the structure (114). After the particulate (120) is separated from the air, air leaves the structure (100) via the air moving element (1108). Specifically in this embodiment the exhaust particle separator (600) and the air moving element (1108) form an exhaust stream that will take in a plurality of particulate (120) from the air inside the structure (114). After the air from the structure (114) is separated from the carbon capture fluid (108), it is then pulled into the (air moving element (1108)) where the residuary air (124) is pushed out of the structure (100). The residuary air (124) that is pushed out of the structure (100) will mix back into the atmosphere free from carbon dioxide. Although the carbon capture fluid (108) would still benefit from a charge, in this embodiment, there is no charge requirement on the tail end of the structure (100) nor is charge required for the carbon capture fluid (108). Instead of relying on charge, the carbon capture system in this embodiment will capture the carbon capture fluid (108) with an exhaust particle separator (600) and air moving element (1108) via centrifugal force, wherein air from the atmosphere (112) is pulled into the structure (100) at a low or high velocity via air moving clement (1108).

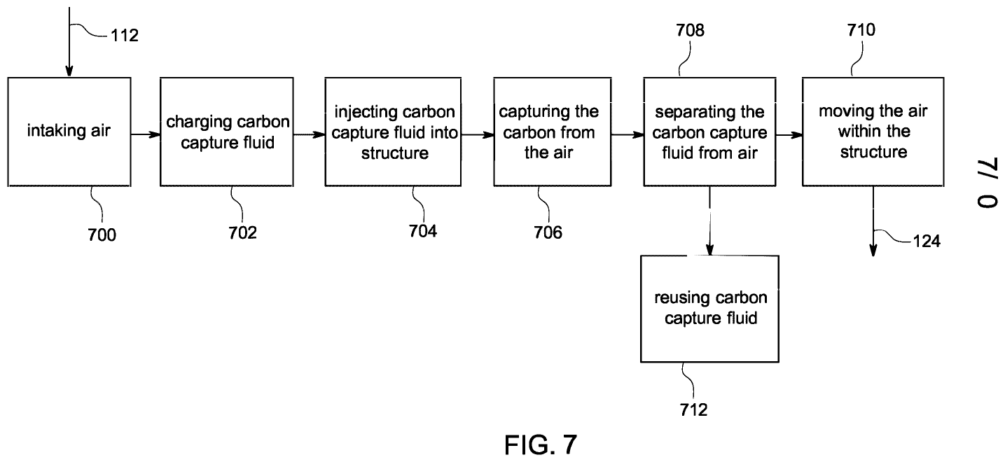

FIG. 7 illustrates a method of capturing carbon dioxide from the atmosphere. The method in this embodiment comprises of first intaking air (700) from the atmosphere (112) into a structure (100). After intaking air from the atmosphere (112), carbon capture fluid (108) is charged (702), cither inside the structure (100) or within the structure (100), to form an electrically charged carbon capture fluid (108). After the charging of the carbon capture fluid (702), the electrically charged carbon capture fluid (108) is injected (704) into the structure (100). The next step requires capturing (706) the electrically charged carbon capture fluid (108) from the air inside the structure (114). After capturing (706) the electrically charged carbon capture fluid (108), the next step requires separating (708) the carbon dioxide from the air inside the structure (114) with a charged capture element (110) that is configured to have an opposing electrical charge in comparison to the electrically charged carbon capture substance (108). In one configuration an exhaust particle separator (600) can be used to separate the electrically charged carbon capture fluid (108) from the air that is inside the structure (114) at a relatively high velocity. After the air from the structure (114) is separated from the electrically charged carbon capture fluid (108) it is then pulled into the air moving element (1108) or any other functionally equivalent mechanism.

In another embodiment fan or fans (122) pull in the resultant particulate (120) inside the charged capture element (110). The fan or fans (122) inside the charged capture element (110) extend across the inner portion of the housing (406) into the outer portion of the housing (404) within the charged capture element (110). The function of the outer housing (406) of the charged capture element (110) is to collect the resultant particulate (120). The collection of the resultant particulate (120) can be achieved using any collection method. Once the carbon dioxide is captured (706) in the charged capture element (110), the air in the structure (114) is moved out of the structure (100). The structure may (100) reuse (126) the left-over carbon capture fluid (108) throughout the process of capturing carbon dioxide from the air inside the structure (114). The reusing (712) of the carbon capture fluid (108) can be achieved either continuously, incrementally, or the carbon capture fluid (108) can be stored or discarded. In addition, the reusing (712) of the carbon capture fluid (108) can be done automatically, manually, or randomly.

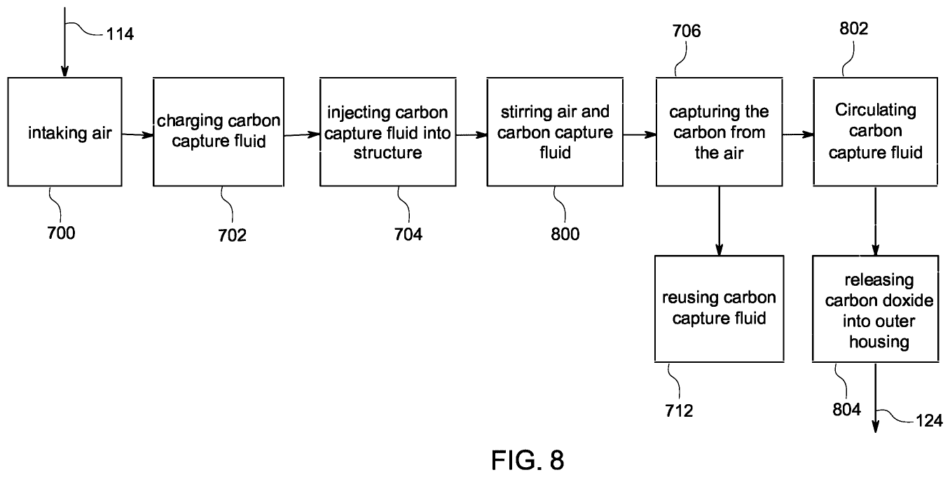

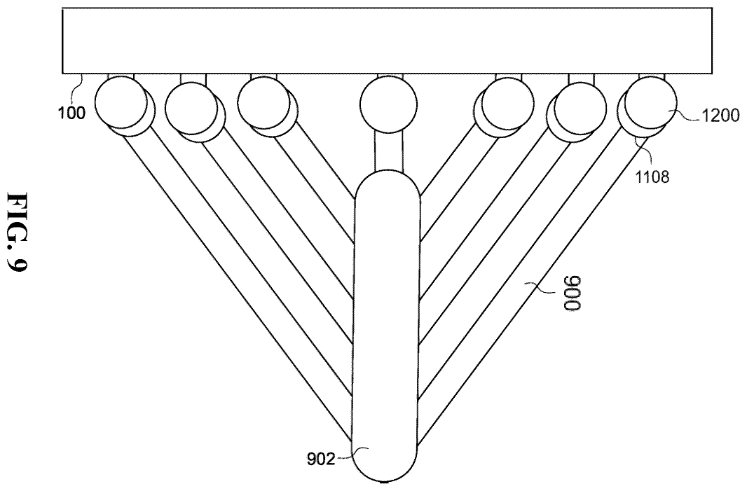

FIG. 8 illustrates another embodiment of a method of capturing carbon dioxide from the atmosphere. The method in this embodiment comprises of intaking air (700) into the structure (100), then the electrically charged carbon capture fluid (108) is charged (702), either inside the structure (100) or within the structure (100), to form an electrically charged carbon capture fluid (108). After the charging of the electrically charged carbon capture fluid (108), the fluid (108) is injected (704) into the structure (100). The next step requires stirring (800) the electrically charged carbon capture fluid (108) in the structure (100) via an electrically insulated mixer (104) and electrically insulated paddle (116). The electrically insulated mixer (104) is not limited to only an electrically insulated paddle (116) and can also be implemented with a fan or fans (122), an electric motor (1014) or an equivalent mixing mechanism. After stirring (800), the next step requires capturing (706) the electrically charged carbon capture fluid (108) in order to capture carbon dioxide from the air inside the structure (114). The next step requires circulating (802) the electrically charged carbon capture fluid (108), and then holding the carbon dioxide. The held carbon dioxide is then released (804) into a holding reservoir (400). The carbon dioxide is then released into an outer housing (404) through centrifugal force. The carbon capture system may reuse (712) the left-over electrically charged carbon capture fluid (108) throughout the process of capturing carbon dioxide from the air inside the structure (114). The reusing of the electrically charged carbon capture fluid (712) can be achieved either continuously or in incremental steps. In addition, the reusing (712) of the electrically charged carbon capture fluid (108) can be done automatically or randomly.

FIG. 9 illustrates another embodiment of the carbon capture system where the components of a system are contained within a structure (100) of sorts built to house the various system components. The shape of the structure can be any shape and size. In addition, it should be noted that the structure (100) is hollow inside for the purpose of removing the restrictive and expensive filter media utilized in legacy systems. In this embodiment it is shown as a rectangle. This structure (100) provides a housing within which other system elements are contained and may take various shapes and sizes dependent upon the volume of air to be processed by the system. The structure (100) comprises of a first intake (102), a distribution element (106), a carbon capture fluid (108), a swirling separator (1200), an air moving element (1108), at least one exhaust (900) and a combined clean air exhaust pipe (902). It should be noted that any separator system can be used in this embodiment. For example, the swirling separator (1200) or the exhaust particle separator (600), or the efficient swirling separator (1201) can be used here. In this figure, the separator that is used is the swirling separator (1200). The number of exhausts (900) or the number of combined clean air exhaust pipes (902) can vary from zero to as many as needed depending on the carbon capture system. Air mixed with carbon capture particulate (108) passes from the structure (100) to the separator inlet (1112). The vanes (1002) inside the swirling separator (1200) add the swirling component driving particulate (120) to the perimeter of the swirling separator (1200) via centrifugal force. Air inside the structure (100) which is the same as the air in the swirling separator (1200), then passes over the apex turn (1004), where air (114) is forced to make a sharper turn than the particulate (120). Air (114) inside the swirling separator (1200) is then redirected straight and out of a swirling motion via second fixed blades (1006) before being pulled through the air moving element (1108) driving residuary air (124) through the system, powered by an electric motor (1014). Carbon capture fluid (108) flows into a primary collection area (1010) where Carbon capture fluid (108) drops to the bottom for collection as air flows incidentally with the carbon capture fluid (108). After carbon capture fluid is separated from the air (108), the air is then pulled into the air moving element (1108) where the air now containing less carbon dioxide is pushed out of the structure (100). The residuary air (124) that is pushed out of the structure will mix back into the atmosphere again. It should be noted that current legacy systems or prior art in the field have been designed to remove approximately 10% of carbon dioxide per meter.

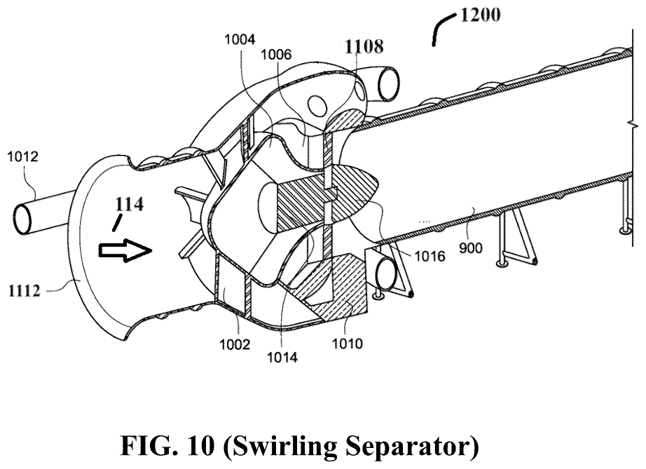

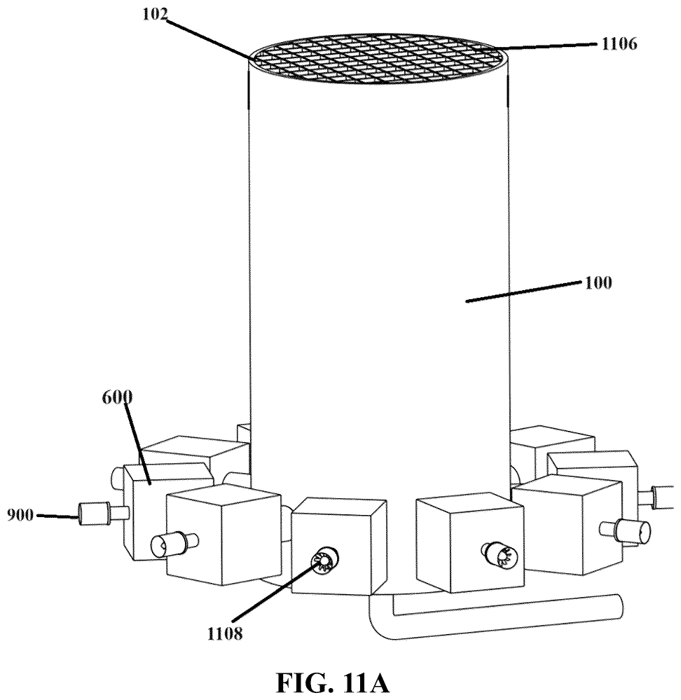

FIG. 10 illustrates the components of the swirling separator (1200) and (air moving element (1108)). Air mixed with particulate (118) passes from the structure (100) to the separator inlet (1112) where the vanes (1002) inside the swirling separator (1200) add the swirling component, driving particulate (120) to the perimeter of the swirling separator (1200) via centrifugal force. Also included is the air moving clement (1108), which is located after the swirling separator (1200), pulls air into one or more swirling separators (1200). The air (124) then passes over an apex turn (1004), where air is forced to make a sharper turn than the particulate (118). Air inside the structure (114) is then redirected straight and out of a swirling motion via second fixed blades (1006) before being pulled through an air moving element (1108). The air moving clement (1108) drives air (124) through the structure (100) and is powered by an electric motor (1014). The particulate (120) then flows into the primary collection area (1010). It should be noted that the pressure drop of the carbon capture system using the swirling separator (1200) is approximately 700 pascals.

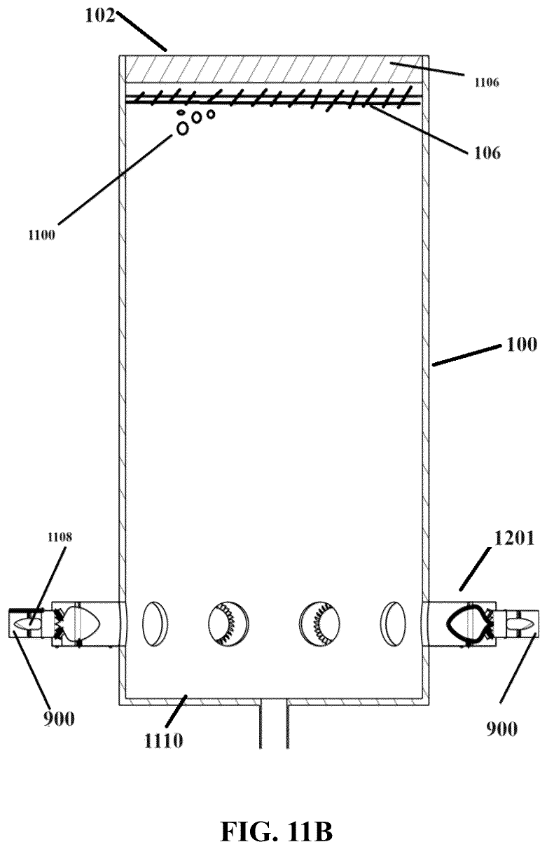

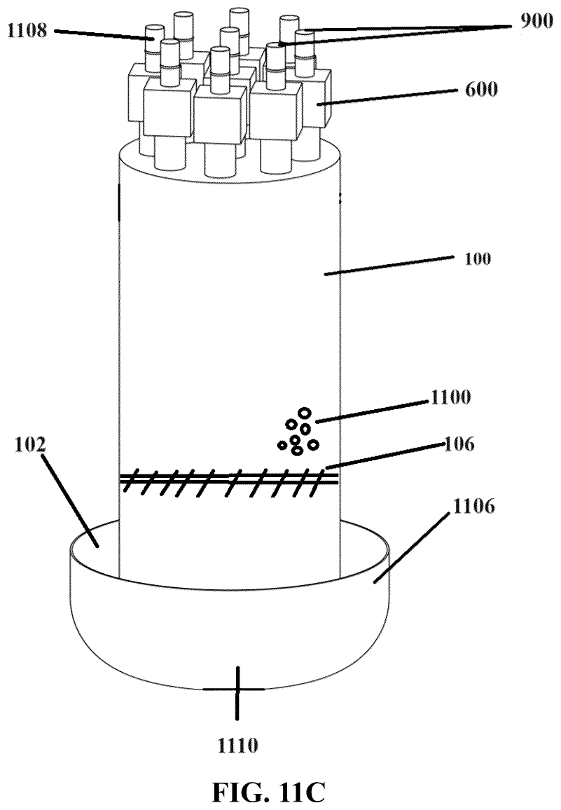

FIGS. 11a and 11b illustrate another embodiment of the carbon capture system where the components of a system are contained within a structure (100) of sorts built to house the various system components. It should be noted that the structure (100) is hollow inside. In this embodiment the structure is shown as a cylinder although a variety of other housing shapes and sizes are feasible dependent upon the volume of air to be processed by the system shapes. This structure (100) provides a housing within which additional system elements are contained. Shown in FIG. 11a is the structure (100) comprises a first intake first intake (102), a distribution element (106), a carbon capture substance (1100), an exhaust (900), an exhaust particle separator (600), a drift control element (1106), an air moving element (1108), and a carbon capture substance collection element (1110). Shown in FIG. 11b is the same as FIG. 11a, except the separator used in this figure is the efficient swirling separator (1201).

It should be noted that the drift control element (1106) can be, but is not limited to, a grate or a bowl-shaped inlet or an active inlet that changes shape or orientation depending on wind shift or a particular shape that prevents carbon capture substance (1100) from being pulled out by the wind. The number of exhausts (900) can vary from one to as many as needed depending on the volume of air moving through the carbon capture system. As air leaves the efficient swirling separator (1201), the air leaves the carbon capture system through the exhaust (900) and mixes back into the environment with decreased levels of carbon dioxide. It should be noted that current legacy systems or prior art in the field have been designed to remove approximately 10% of carbon dioxide per meter.

The carbon capture substance (1100) which can be but is not limited to a carbon capture fluid (108) which can be solvents or sorbents, where the carbon dioxide is absorbed into the substance, can be made with but is not limited to: primary amines such as monoethanolamine (MEA), isobutylamine (IBA), ethylamine, propylamine, secondary amines such as diethanolamine (DEA), piperazine (PZ), diisopropylamine (DIPA), 2-methylaminoethanol (MAE) tertiary amines such as tetraethylenepentamine (TEPA), N-methyldiethanolamine (MDEA), 2-(dimethylamino) ethanol (DMEA), N-diethylethanolamines (DEEA), 2-amino-1-methyl-2-propanol (AMP), aqueous solutions with ionic concentration such as potassium hydroxide (KOH), sodium hydroxide (NaOH) powdered hydroxides and the like. In addition, the combination can also include water.

Similar to FIGS. 9 and 10, air from the atmosphere (112) containing carbon dioxide, comes into the carbon capture system, and passes through one or more drift control devices (1106). Drift control devices (1106) prevent external winds from removing carbon capture substance (1100) such as a fluid, a solid, or a gas or any combinations thereof from the carbon capture system. In addition, there is no requirement in this embodiment of the invention for the carbon capture substance (1100) to be electrically or magnetically charged for the carbon capture system to function. However, in another embodiment the carbon capture substance (1100) can be electrically or magnetically charged. Thereafter, similar to the embodiment in FIGS. 9 and 10, the air inside structure (100) moves through one or more distribution elements (106), to distribute the carbon capture substance (1100) and mix with the air inside the structure (114). A nozzle or other distribution type element distributes the carbon capture substance (1100). The carbon capture substance (1100) moves toward either floor of the structure (100) or another section of the structure (100) as it travels either downward, upward, or sideways with the airflow removing carbon dioxide from the air in the process. It should be noted that the embodiment in FIGS. 11a and 11b does not include the recirculation pipes (1012) as shown in FIG. 10.

In one or more embodiments of the present invention the majority (approximately 95-100%) of the carbon capture substance (1100) is collected in a pool before the carbon capture substance (1100) is removed to be recycled and or regenerated and recycled or reused in the carbon capture system. The air with the remaining (approximately 0-5%) carbon capture substance (1100), exits the structure (100) and enters the separator inlet (1112) of the exhaust particle separator (600).

In one or more embodiments of the invention less carbon capture substance (1100) (70-95%) is collected in a pool before it is removed to be recycled and or regenerated or reused in the carbon capture system. The remaining (approximately 5-30%) of the carbon capture substance (1100) exits the structure (100) and enters separator inlet (1112) with the airflow as discussed above.

In another embodiment of the present invention, approximately 40-70% of carbon capture substance (1100) is collected in a pool before it is removed and possibly regenerated or reused as discussed above. The remaining (approximately 30-60%) of carbon capture substance (1100) goes through the separator (600) and is collected.

The exhaust particle separator (600) can be, but is not limited to, a cyclone separator or a U-bend separator or a swirling or mixing separator. The air moving element (1108), which is located after the exhaust particle separator (600), pulls air into one or more exhaust particle separators (600). The air moving element (1108) can be a fan, or any equivalent structure that performs the function of moving air. It should be noted that in one or more embodiments of the invention, multiple exhaust particle separators (600) can be used with one central air moving element (1108). The number of exhaust particle separators (600) and air moving elements (1108) can vary depending on the carbon capture system. In addition, the air moving element (1108) may be attached to the exhaust particle separator (1108). Similar to FIG. 10, as air is pulled into the exhaust particle separators (600), it causes the air and carbon capture substance (1100) to change direction. This change in the direction can be caused by the shape of the exhaust particle separator (600) or the elements within the exhaust particle separators (600) which cause air and carbon capture substance (1100) to change direction. The change in direction causes air and carbon capture substance to have a radial component of acceleration that pushes carbon capture substance (1100) away from the exhaust (900). This is because the radial component of acceleration slings the carbon capture substance (1100) particles to the sides of the exhaust particle separator (600) casing and because the particles are heavier, they have more momentum which does not allow for the carbon capture substance (1100) to make the abrupt turn into the exhaust with the air. Instead, the carbon capture substance (1100) flows around the given separator or any combination, manner where the carbon capture substance (1100) is extracted through at least one collection element (1010). As air enters the separator inlet (1112), it goes through the system where aerodynamics cause air to lose some of its energy in the form of a pressure drop. The pressure difference between the exhaust (900) and the ambient conditions can be used as a method of measuring the efficiency of the carbon capture system. Depending on the type of separator used in the carbon capture system, the pressure drop due to the exhaust particle separator (600) can vary from a range of approximately 3.8-700 pascals. For example, the cyclone separator can achieve a pressure drop of approximately 20 pascals. Whereas the U-Bend separator can achieve a pressure drop of about 10 pascals. The efficient swirling separator is capable of a pressure drop as low as 5 pascals. Other less efficient, but equally functionally effective separators with pressure drops up to 700 pascals are attainable and remain within the scope of one or more embodiments of the invention.

It should be noted that the exhaust particle separator (600) could be attached to the structure (100) in one or more embodiments of the invention. The exhaust particle separator (600) can be attached to the side, or top, or below or any combinations thereof to the body of the structure (100).

FIG. 11c illustrates an instance of the carbon capture system where the components of the system are contained within a structure (100) of sorts built to house the various system components. In one or more embodiments of the invention, it is shown as a cylinder. This aspect of the invention is similar to FIGS. 9 and 10, but without the recirculation pipes (1012). The structure (100) provides a housing within which other system elements are contained and may take various shapes and sizes dependent upon the volume of air to be processed by the system. The structure (100) comprises a carbon capture substance (1100), a drift control element (1106), an air moving element (1108), a carbon capture substance collection element (1110) and at least one exhaust (900). In this embodiment of the invention described herein, one or more exhaust particle separators (600) are located on the top of the structure (100) in a vertical configuration, which means the majority of the carbon capture substance (1100) goes through the exhaust particle separator (600) (approximately 95-100%). However, the system can be configured to have less carbon capture substance (1100) go through the exhaust particle separator (600) if such is desirable. It should be noted that in this configuration the carbon capture substance (1100) will be distributed, based on the velocity of the air flow in an upward manner. Therefore, a minimal amount of carbon capture substance (1100) will drop downward toward the carbon capture substance collection element (1110). In one or more embodiments of the invention, the shape of the system prevents a crosswind from coming and blowing away the carbon capture substance (1100). The substance collection element (1110) bowl in this instance functions similar to a first intake (102) and a drift control element (1106).

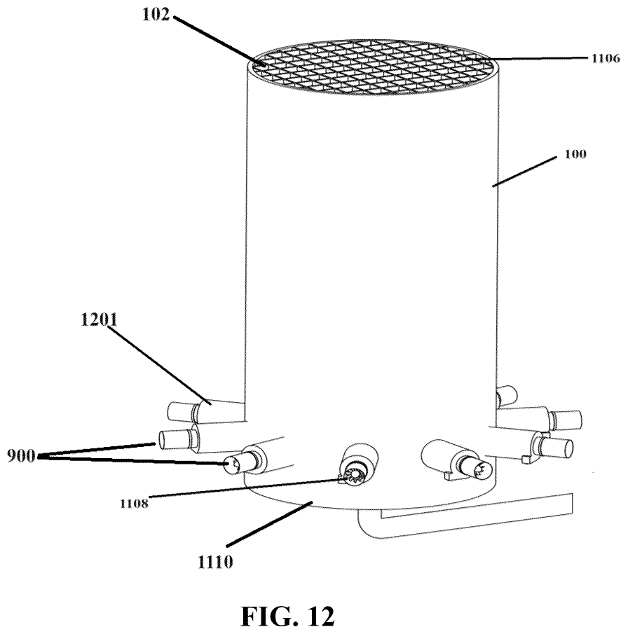

FIG. 12 illustrate one or more embodiments of the carbon capture system where the components of a system are contained within a structure (100) of sorts built to house the various system components. In this instance the structure is shown as a cylinder, but other shapes are feasible. The system depicted here in FIG. 12 is similar to FIG. 9, but with certain components removed (for example the Recirculating Pipe 1012). This structure (100) provides a housing within which other system elements are contained and may take various shapes and sizes dependent upon the volume of air to be processed by the system. The structure (100) comprises a distribution element (106), a carbon capture substance (1100), a drift control element (1106), an air moving element (1108), a carbon capture substance collection element (1110). In one or more embodiments of the invention, the exhaust particle separator (600) is an efficient swirling separator (1201) and comprises a separator inlet (1112), an internal exhaust inlet (1114), an exhaust (900) and one or more vanes (1002). The air moving element (1108) is located after the efficient swirling separator (1201) and or the exhaust particle separator (600). It should be noted that in the description provided in FIG. 10 the second inlet is the inlet to the separator. However, in this example the second inlet is an inlet internal to the separator that directs the air into the air moving element (1108).

The functionality of this example mirrors the system implementation described in FIGS. 9, 10, 11a and 11b. However, the difference is in the internal elements of the swirling separator (1201) and its respective pressure drop and, in this example, there are no recirculation pipes (1012). The air and carbon capture substance mixture changes direction because the air moving element (1108) pulls air with such force that once the mixture hits the stationary vanes (1002), it changes direction. The change in direction causes the mixture to rotate. The rotation causes air and carbon capture substance (1100) to have a radial component of acceleration that pushes carbon capture substance (1100) away from one or more exhaust (900). This is because the radial component of acceleration slings the carbon capture substance (1100) particles to the sides of the efficient swirling separator (1201) and or the exhaust particle separator (600) casing, and because the particles are heavier, they have more momentum which does not allow for the particles to make the abrupt turn with the air. Instead, the carbon capture substance (1100) flows around the separator or any combinations, motion where it is extracted through a primary collection area (1010). The position and function of the internal exhaust inlet (1114) is to draw air into the air moving element (1108) while preventing carbon capture substance (1100) from exiting through the exhaust (900). It should be noted that in one or more embodiments of the invention, multiple efficient swirling separators (1201) can be used with one central air moving element (1108). The number of swirling separators (1200) and air moving elements (1108) can vary depending on how the implementor wishes to move air through the carbon capture system.

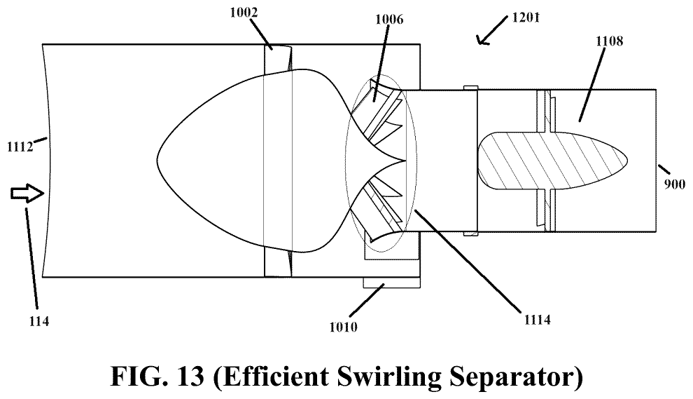

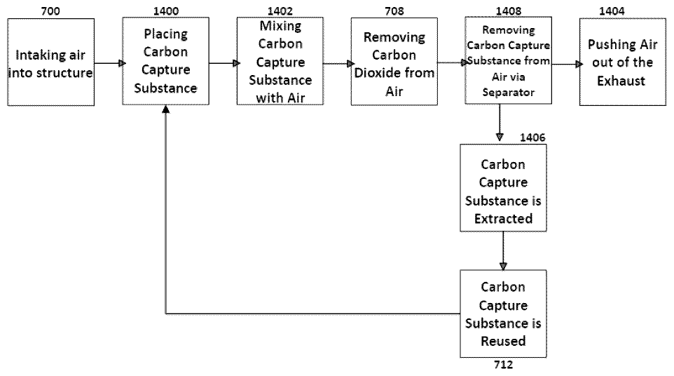

FIG. 13 illustrates the efficient swirling separator (1201) and the air moving element (1108). Similar to FIGS. 9 and 10, the efficient swirling separator (1201) is composed of one or more vanes (1002) to swirl the air, and one or more Second fixed blades (1006), which can de-swirl the air in the efficient swirling separator (1201), a separator inlet (1112), an internal exhaust inlet (1114) and an exhaust (900). The air moving clement (1108) can be either attached to the efficient swirling separator (1201) or can be spaced at a distance and still function by pulling air into the efficient swirling separator (1201). It should be noted that the efficient swirling separator (1201) has a pressure drop of approximately 3.8 pascals whereas the swirling separator (1200) of FIG. 10 has a pressure drop of approximately 700 pascals. The lower the pressure drop the more efficient the system and therefore the efficient swirling separator (1201) is more efficient compared to the swirling separator (1200). The functionality of the efficient swirling separator (1201) is discussed above in FIG. 12. It should be noted that in this embodiment, there are no recirculation pipes (1012) as shown in FIGS. 9 and 10. In addition, there is also at least one primary collection area (1010) located in the efficient swirling separator (120). The function of the primary collection area (1010) is similar to what is described in FIG. 10.

FIG. 14 illustrates a method of capturing carbon dioxide from the atmosphere using the exhaust particle separator (600). It should be noted that any of the separators disclosed can be used. For example, the swirling separator (1200) or the efficient swirling separators (1201) can also be used. The method in this example described here comprises intaking air (700) from the atmosphere (112) into a structure (100). After intaking air from the atmosphere (112), carbon capture substance (1100) is placed (1400) into the structure (100). The carbon capture substance (1100) is mixed (1402) with the air inside the structure (114). After mixing (1402) the carbon capture substance (1100), the carbon dioxide from the air inside the structure (708) is removed via absorption or a chemical reaction with the carbon capture substance (1100). Next involves separating (1408) the carbon capture substance (1100) from the air which is achieved via exhaust particle separator (600). The exhaust particle separators (600) cause air inside the structure (114) to change direction and rotate. As a result of the rotation, a radial component of acceleration is created that pushes (1408) carbon capture substance (1100) away from the internal exhaust inlet (1114). This is because the radial component of acceleration slings the carbon capture substance (1100) particles to the sides of the exhaust particle separator (600) casing and because the particles are heavier, they have more momentum which does not allow for the particles to make a sharp turn with the air. Decarbonized air is pushed outside the structure (1404) through the exhaust (900) and reintroduced to the environment. The next step includes the carbon capture substance (1100) being extracted (1406) through the carbon capture substance collection element (1110) for recycling or reuse (712).

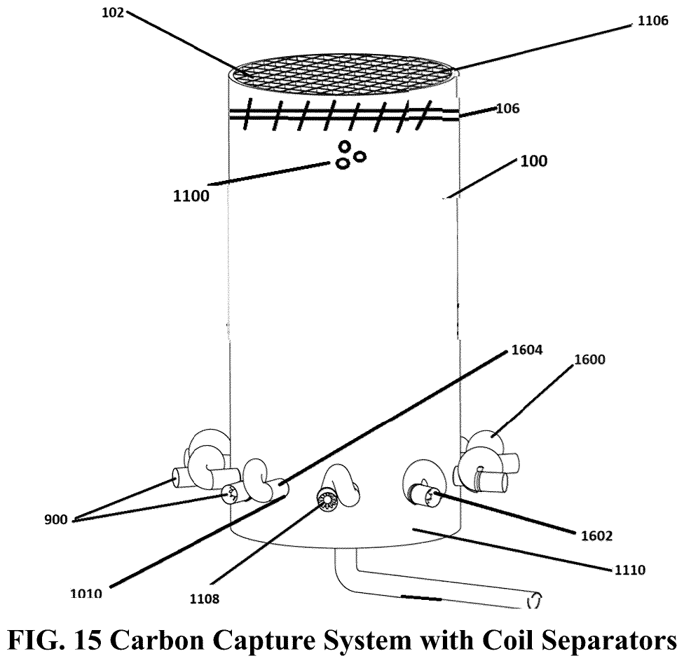

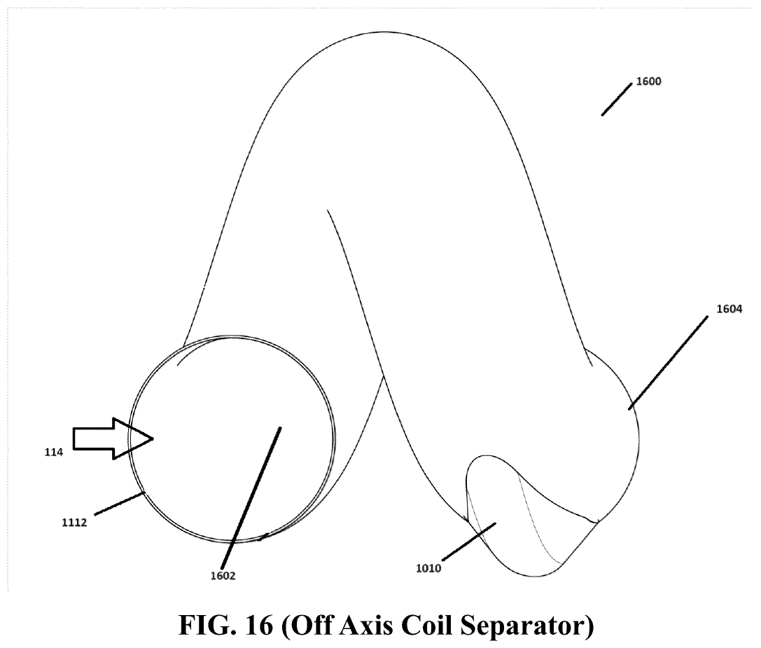

FIG. 15 illustrates one or more embodiments of the carbon capture system where the components of a system are contained within a structure (100) of sorts built to house the various system components. In this instance the structure is shown as a cylinder, but other shapes are feasible. The system depicted here in FIG. 15 is similar to FIG. 12, but with certain components removed (for example the swirling separator 1201). This structure (100) provides a housing within which other system elements are contained and may take various shapes and sizes dependent upon the volume of air to be processed by the system. The structure (100) comprises a distribution element (106), a carbon capture substance (1100), a drift control element (1106), an air moving element (1108), a carbon capture substance collection element (1110). In one or more embodiments of the invention, the coil separator (1600) comprises of an exhaust (900). The air moving element (1108) is located after the coil separator (1600). It should be noted that the carbon capture system in FIG. 15 can function without the air moving element (1108) provided the local wind speeds are sufficiently high. The air moving element (1108) can be a fan, or a series of fans in shapes and different sizes, or an engine or an equivalent mechanical structure providing the same equivalent function as a fan. Also included is a separator outlet (1604) which is a structure that interfaces with the air moving element (1108). The function of the separator outlet (1604) is to direct air into the air moving element (1108).

Also included is the primary collection area (1010) which is attached to the coil separator (1600). It should be noted that there may be more than one primary collection area (1010) located throughout the coil separator (1600).

The functionality of this example mirrors the system implementation described in FIGS. 9, 10, 11a and 11b and 12. However, the difference is in the internal elements of the coil separator (1600). The coil separator (1600) is configured (mainly due to the shape) to force air and carbon capture substance to pick up a radial component of acceleration by changing the direction of the flow. The radial component of acceleration slings the carbon capture substance (1100) against a surface (1602) located inside the coil separator (1600).

The collection of carbon capture substance (1100) can be achieved in several ways. One way is when the carbon capture substance (1100) is slung against the surface (1602) where it gets collected by the primary collection area (1010). In this configuration, the centrifugal force will sling all of the carbon capture substance (1100) into the primary collection area (1010) located near the separator outlet (1604 or multiple collection areas along the length of the separator. Another way that the carbon capture substance (1100) can be collected is when the coil separator (1600) is made out of a porous material or a material with a plurality of holes located throughout the coil separator (1600). In this configuration the carbon capture substance (1100) will get collected throughout the entire coil separator (1600) continuously. In this configuration it should be noted that there will be more than one primary collection area (1010) located throughout the coil separator (1600).

It should be noted that in one or more embodiments of the invention, multiple coil separators (1600) can be used with one central air moving element (1108). The number of coil separators (1600) and air moving elements (1108) can vary depending on how the implementor wishes to move air through the carbon capture system.

FIG. 16 illustrates the off axis coil separator (1600) embodiment. It should be noted that the reason why it is called the off-axis coil separator (1600) is because air enters through the separator inlet (1112) at approximately 90 degrees in reference to the coil separator's (1600) axis of rotation. The coil separator (1600) is hollow and can be made from a variety of materials such as high-density polyethylene plastic, polypropylene plastic, polyvinyl chloride (PVC), composites (fiberglass, carbon fiber), or even various metal such as stainless steel, coated steel, coated iron. As noted above the walls (1602) of the coil separator (1600) can be solid or made from a porous material or an equivalent structure. Also included in FIG. 16 are the separator inlet (1112), the separator outlet (1604) and a primary collection area (1010). It should be noted that the coil separator (1600) has a pressure drop of approximately 3.0 pascals. The lower the pressure drop the more efficient the system. The functionality of the coil separator (1600) is discussed above in FIG. 15.

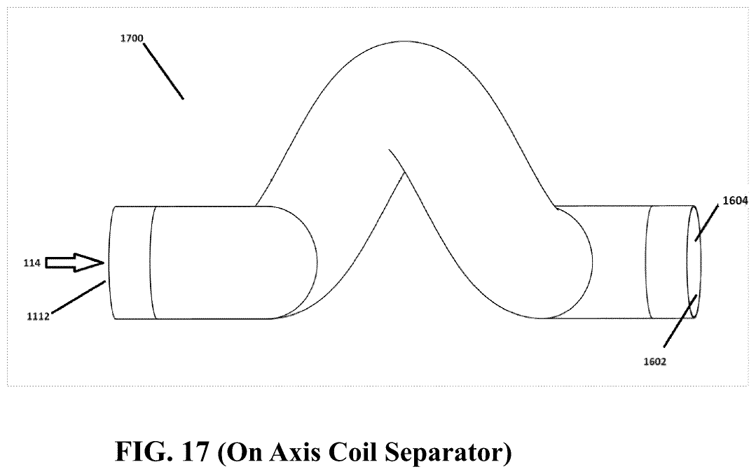

FIG. 17 illustrates the on axis coil separator (1700) embodiment. It should be noted that the reason why it is called the on axis coil separator (1700) is because air enters through the separator inlet (1112) approximately parallel in reference to the coil separator's (1700) axis of rotation. The coil separator (1700) is hollow and can be made from a variety of materials such as high-density polyethylene plastic or polypropylene plastic, PVC, composites (fiberglass, carbon fiber), or even various metal such as stainless steel, coated steel, coated iron. The walls (1602) of the coil separator (1700) which can be elongated or can be solid or made from but not limited to a porous material or an equivalent structure. Also included in FIG. 17 are the separator inlet (1112), the separator outlet (1604) and a primary collection area (1010). It should be noted that the coil separator (1700) in FIG. 17 has a pressure drop of at least 3 pascals. The lower the pressure drop the more efficient the system.

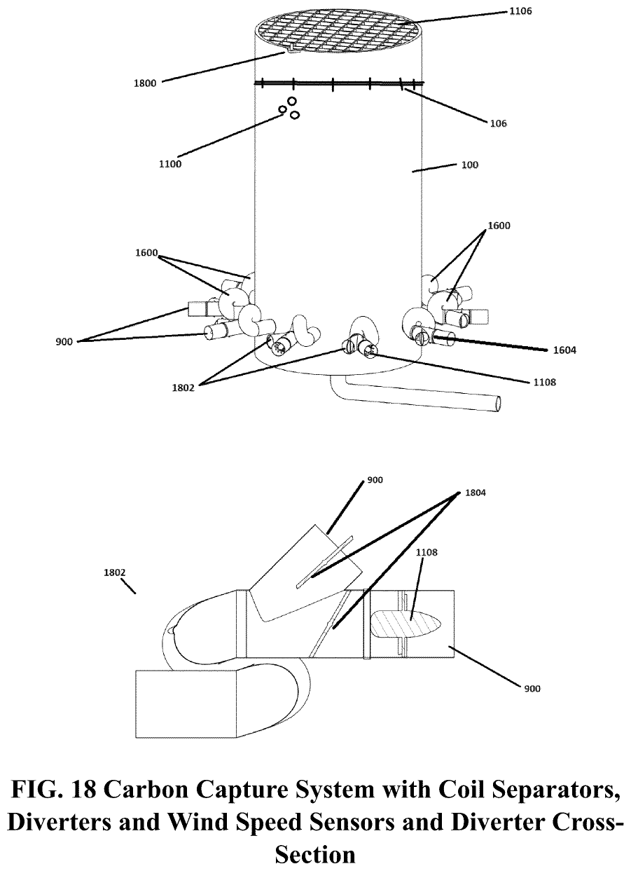

FIG. 18 illustrates a carbon capture system with a coil separator embodiment. In this instance the structure is shown as a cylinder, but other shapes are feasible. The system depicted here in FIG. 18 is similar to FIG. 15, but with certain components removed (for example the swirling separator (1201). The structure (100) provides a housing within which other system elements are contained and may take various shapes and sizes dependent upon the volume of air to be processed by the system. The structure (100) comprises a distribution element (106), an exhaust (900), a carbon capture substance (1100), a drift control element (1106), a wind speed sensor (1800), or an equivalent structure which detects wind. At least one diverter element (1802) is controlled by the wind speed sensor (1800). The sensor valve (1800) detects either automatically or manually when wind velocity is higher than a predetermined wind velocity value set within the carbon capture system. When this event occurs, the wind speed sensor (1800) opens at least one diverter element (1802) which thereby directs airflow away from the air moving element (1108) and towards the separator outlet (1604). It should be noted that for a Carbon Capture system when one diverter element (1802) has at least two dampers (1804). When one damper (1804) opens the other damper (1804) closes and vice versa. It should be noted that when one of the dampers (1804) opens it enables air to go to the exhaust (900). Additionally, when one damper (1804) closes, the diverter element is closed off from the air moving element (1108). Both dampers (1804) are not open at the same time. It should be noted that when a high wind velocity condition is detected by the wind speed sensor (1800), the carbon capture system is also configured to shut off the air moving element (1108) power thereby saving on overall power consumption of the system. It should be noted that in the case of a high wind velocity condition, a reserve number of extra coil separators (1600) that are not typically used, could be utilized to allow the excess air to go through the unused coil separators (1600) without the use of any air moving elements (1108). This means that the system depicted in FIG. 18 can, during high wind velocity conditions, increase the amount of air flow into the system in order to capture more carbon without the use of air moving elements (1108) thereby saving power consumption that is normally used by the air moving elements (1108). It should be noted that when more air flow is directed into the carbon capture system, the amount of Carbon Capture substance (1100) can also be adjusted in order to allow for maximum carbon capture. This adjustment can be manual or automatic depending on the application. In addition, the carbon capture system in FIG. 18 has a pressure drop of at least 3 pascals.

Thus, a new carbon capture system with an efficient adaptable coil separator has been described. The reader should note however that the claims set forth below and the full scope of their equivalents are what define the scope of the invention.

1. A carbon capture system comprising:
a structure, wherein said structure is hollow;
a carbon capture substance for distribution within said structure;
at least one drift control element, wherein said at least one drift control element is attached to said structure, wherein said at least one drift control element prevents outside air from removing said carbon capture substance from said structure;
at least one distribution element configured to distribute said carbon capture substance into air inside said structure, wherein said air passes through said at least one drift control element;
at least one wind speed sensor, wherein said at least one wind speed sensor is attached to said structure;
at least one diverter element, wherein said at least one diverter element is controlled by said wind speed sensor;
at least one separator inlet, wherein said air and an amount less than or equal to approximately 100% of said carbon capture substance from said structure enter said inlet;
at least one coil separator, wherein said at least one coil separator is attached to said separator inlet comprising:
at least one exhaust outlet, wherein said air exits said at least one coil separator;
at least one air moving element, wherein said air moving element pulls air through said at least one coil separator, wherein said at least one air moving element is configured to be diverted, wherein said at least one air moving element is controlled by said wind speed sensor; and
at least one primary collection area, wherein said carbon capture substance is captured in said at least one primary collection area.

2. The carbon capture system of claim 1, wherein said at least one wind speed sensor detects a wind velocity thereafter opening said at least one diverter element to direct air away from at least one air moving element.

3. The carbon capture system of claim 1, wherein said at least one wind speed sensor detects a wind velocity thereafter closing said at least one diverter element to direct air toward at least one air moving element.

4. The at least one coil separator of claim 1, wherein said at least one coil separator is configured to change said direction of said air and said carbon capture substance, thereby said change in direction results said air and said carbon capture to pick up a radial component of acceleration.

5. The radial component of acceleration of claim 4, wherein said radial component of acceleration slings said carbon capture substance against a surface inside said at least one coil separator.

6. The carbon capture substance of claim 1, wherein said carbon capture substance is collected after said carbon capture substance contacts said surface, wherein said air exists said at least one coil separator via at least one exhaust outlet.

7. A carbon capture system comprising:
a structure, wherein said structure is hollow;
a carbon capture substance for distribution within said structure;
at least one drift control element, wherein said at least one drift control element is attached to said structure, wherein said at least one drift control element prevents outside air from removing said carbon capture substance from said structure;
at least one distribution element configured to distribute said carbon capture substance into air inside said structure, wherein said air passes through said at least one drift control element;
at least one separator inlet, wherein said air and an amount less than or equal to approximately 100% of said carbon capture substance from said structure enter said inlet;
at least one coil separator, wherein said at least one coil separator is attached to said separator inlet comprising:
at least one exhaust outlet, wherein said air exits said at least one coil separator;
at least one air moving element, wherein said air moving element pulls air through said at least one coil separator; and
at least one primary collection area, wherein said carbon capture substance is captured in said at least one primary collection area.

8. The carbon capture system of claim 7, wherein at least one air moving element pulls said air through said at least one coil separator and out said at least one exhaust.

9. The at least one coil separator of claim 7, wherein said at least one coil separator is configured to change said direction of said air and said carbon capture substance, thereby said change in direction results said air and said carbon capture substance to pick up a radial component of acceleration.

10. The radial component of acceleration of claim 9, wherein said radial component of acceleration slings said carbon capture substance against said surface inside said at least one coil separator.

11. The carbon capture substance of claim 7, wherein said carbon capture substance is collected after said carbon capture substance contacts said surface, wherein said air exits said at least one coil separator via at least one exhaust outlet.
